(19) United States
(12) Patent Application Publication
(10) Pub. No.: US 2017/0330663 A1
(43) Pub. Date: Nov. 16, 2017

(54) Superconducting Device With Coil Devices And Cooling Device

(71) Applicant: Siemens Aktiengesellschaft, Muenchen (DE)

(72) Inventors: Anne Bauer, Fuerth (DE); Joern Grundmann, Grossenseebach (DE); Peter Kummeth, Herzogenaurach (DE)

(73) Assignee: Siemens Aktiengesellschaft, Muenchen (DE)

(21) Appl. No.: 15/525,766

(22) PCT Filed: Nov. 18, 2015
(86) PCT No.: PCT/EP2015/076930

§ 371 Date: May 10, 2017

(30) Foreign Application Priority Data
Nov. 28, 2014 (DE) 10 2014 224 363.7

(51) Int. Cl. H01F 6/06; H01F 6/04; H01F 6/00

(52) U.S. Cl. CPC H01F 6/06; H01F 6/04; H01F 2006/001

(57) ABSTRACT

The present disclosure relates to a superconducting apparatus. The embodiments may include a system comprising at least two electrical coil devices and a cooling apparatus for cooling the coil devices with the aid of a coolant. For example, a superconducting apparatus may include: two electrical coil devices, wherein at least one comprises a superconducting coil device; a cooling apparatus for the coil devices; and a first connecting line between the two electrical coil devices including both a first electrical conductor connecting the two coil devices and a first coolant pipe transporting coolant between the two coil devices.

### CROSS-REFERENCE TO RELATED APPLICATIONS

This application is a U.S. National Stage Application of International Application No. PCT/EP2015/076930 filed Nov. 18, 2015, which designates the United States of America, and claims priority to DE Application No. 10 2014 224 363.7 filed Nov. 28, 2014, the contents of which are hereby incorporated by reference in their entirety.

### TECHNICAL FIELD

The present disclosure relates to a superconducting apparatus. The embodiments may include a system comprising at least two electrical coil devices and a cooling apparatus for cooling the coil devices with the aid of a coolant.

### BACKGROUND

Known superconducting apparatuses may include one or more superconducting coil devices. A superconducting coil device usually has at least one coil winding with a superconducting conductor material. Said coil winding may be, for example, a coil winding of a transformer or a coil winding of a superconducting machine, e.g., a superconducting rotor winding, a superconducting stator winding, or superconducting rotor and stator windings which are present in a machine together.

The superconducting apparatuses described may be part of an electrical machine, e.g., a motor or a generator. In an apparatus of this kind, either only the transformer may have a superconducting coil device or only the machine may have a superconducting coil device. In some cases both the transformer and the machine each have at least one superconducting coil device.

A combination of this kind of a transformer and a motor in a superordinate apparatus may be used, for example, in rail vehicles. The coil devices of an apparatus of this kind—both the superconducting and the normally conducting coil devices—can then be cooled by a common cooling apparatus with the aid of a coolant.

German patent application bearing the file reference 102014208437.7, which is not a prior publication, describes, for example, a cooling device for at least two components to be cooled, at least one of which comprises a superconductor, wherein all the components are cooled by the same cooling medium which is guided in a closed cooling circuit.

### SUMMARY

The teachings of the present disclosure may be embodied in a superconducting apparatus of the kind outlined in the introductory part. An apparatus of this kind may offer improved thermal insulation for at least of one of the coil devices from the warm outer environment. Teachings may be embodied in a superconducting apparatus with improved electrical current supplies for the coil devices, e.g., with low-resistance current supplies.

For example, some embodiments may include a superconducting apparatus (1), comprising at least two electrical coil devices (3, 5), at least one of which is designed as a superconducting coil device (3, 5), and comprising a cooling apparatus (7) for cooling the coil devices (3, 5) with the aid of a coolant (9). The apparatus (1) may have at least one first connecting line (11a) between the two electrical coil devices (3, 5), which first connecting line comprises both a first electrical conductor (13) for electrically connecting the two coil devices (3, 5) and also a first coolant pipe (15) for transporting coolant (9) between the two coil devices (3, 5).

Some embodiments have only one cooling apparatus (7), wherein the cooling apparatus (7) is designed in order to circulate coolant (9) in the form of a closed circuit from a cold head (17) to the at least two coil devices (3, 5) and back.

In some embodiments, one of the coil devices (3) is electrically connected to an outer electrical circuit only by means of the at least one connecting line (11a).

In some embodiments, there are two connecting lines (11a, 11b) between the two electrical coil devices (3, 5) which each comprise both an electrical conductor (13) for electrically connecting the two coil devices (3, 5) and also a coolant pipe (15) for transporting coolant (9) between the two coil devices (3, 5).

In some embodiments, at least one coil device (5) is connected to at least one further connection line (21a) which once again has both an electrical conductor for connection to an outer electrical circuit and also a coolant pipe for transporting coolant.

In some embodiments, the two electrical coil devices (3, 5) are designed as superconducting coil devices.

In some embodiments, a first electrical coil device (3) is designed as part of an electrical machine, and a second electrical coil device (5) is designed as a transformer.

In some embodiments, the two electrical coil devices (3, 5) have different maximum operating temperatures, and in which the cooling apparatus (7) is designed in order to conduct coolant (9) from a cold head (17) firstly to the coil device (3) with the relatively low maximum operating temperature and then by means of the at least one connecting line (11a) to the coil device (5) with the relatively high maximum operating temperature.

In some embodiments, the electrical conductor (13) of the at least one connecting line (11a) can be cooled to a cryogenic temperature by the coolant (9) in its coolant pipe (15).

In some embodiments, the electrical conductor (13) of the at least one connecting line (11a) has a superconducting conductor material.

In some embodiments, the electrical conductor (13) and the coolant pipe (15) of the at least one connecting line (11a) run coaxially in relation to one another.

In some embodiments, the at least one connecting line (11a) has at least two coolant pipes (15a, 15b) which run coaxially in relation to one another.

In some embodiments, at least one coolant pipe (15) of a connecting line (11a) has an electrically conductive material in the region of its pipe casing, which electrically conductive material is designed as an electrical conductor (13) of the connecting line (11a).

In some embodiments, at least one electrical conductor (13) of a connecting line (11a) is guided in the interior of a coolant pipe (15).

Some embodiments may include a vehicle (25) comprising an apparatus (1) as described above, which apparatus is designed as a drive apparatus.

### BRIEF DESCRIPTION OF THE DRAWINGS

The teachings of the present disclosure will be described below using some exemplary embodiments with reference to the appended drawings, in which:

FIG. 1 shows a schematic basic illustration of an apparatus according to a first exemplary embodiment,

FIG. 2 shows a schematic basic illustration of an apparatus according to a second exemplary embodiment,

FIG. 3 shows a schematic cross section of a connecting line according to a third exemplary embodiment,

FIG. 4 shows a schematic cross section of a connecting line according to a fourth exemplary embodiment,

FIG. 5 shows a schematic cross section of a connecting line according to a fifth exemplary embodiment,

FIG. 6 shows a schematic cross section of a connecting line according to a sixth exemplary embodiment, and

FIG. 7 shows a basic diagram of a vehicle according to a seventh exemplary embodiment.

### DETAILED DESCRIPTION

One disadvantage of the superconducting apparatuses known to date and comprising a plurality of coil devices is that each of these coil devices is equipped with its own current supplies for connection to an outer electrical circuit. Each current supply constitutes a thermal bridge between the coil and the outer environment. Thermal bridges of this kind are particularly disadvantageous in the case of the superconducting coil devices; conductor materials must be cooled to cryogenic temperatures below the critical temperature of the superconductor. Further disadvantages of the known apparatuses are caused by the relatively high resistances of the typically normally conducting current supplies and by the space requirement for these current supplies.

The superconducting apparatus according to the teachings of the present disclosure includes two electrical coil devices, at least one of which is designed as a superconducting coil device. It further comprises a cooling apparatus for cooling the coil device with the aid of a coolant. The apparatus has at least one first connecting line between the two electrical coil devices, which first connecting line comprises both a first electrical conductor for electrically connecting the two coil devices and also a first coolant pipe for transporting coolant between the two coil devices.

In other words, the two electrical coil devices are connected to one another by means of the connecting line such that both electrical contact and also transportation of coolant between the two coil devices is made possible by means of this combined line. Therefore, at least one current supply for one of the two coil devices and at least one coolant pipe are guided together within this connecting line.

In this context, the common guidance of the current supply and the coolant pipe within one connecting line means that the current supply and the coolant pipe are conducted within a common outer channel, e.g., together in the interior of a common sheathing or within a common pipe and/or a common cutout. In particular, the current supply and the coolant pipe can run parallel to one another. They can, in principle, be arranged adjacent to one another and also be situated one in the other. Numerous refinements are possible in this case, some of which are described in more detail further below.

Some advantages of the coil device described herein take effect when the two electrical coil devices have components which must be severely cooled, e.g., when the two coil devices have superconducting coil windings. However, when only one of the coil devices has a superconducting coil winding and the second coil device is based on normally conducting conductor material, pronounced cooling of this second coil device may also be advantageous, e.g., to reduce the line resistance and/or to dissipate lost heat.

Irrespective of the specific design of the coil windings, when cooled coil windings are used, the current supply for at least one of the coil devices may be guided together with the coolant between the two coil devices. The current supply for the one coil device can then be effectively thermally coupled to the coolant, which is transported in the coolant pipe, within the connecting line, and the electrical conductor of the connecting line can be cooled by this thermal contact to a low temperature, for example to a cryogenic temperature below 100 K.

Such an arrangement may provide a particularly low resistance of the electrical conductor owing to the cooling, as a result of which the line losses and the associated development of heat can be kept low. Secondly, owing to the cooling of the electrical connecting conductor, an additional thermal bridge in the region of the current supply for the one coil device or for both coil devices can be avoided. The current supplies which connect the coil devices to the warm components of an outer electrical circuit cause a thermal leakage at the same time owing to the typically high thermal conductivity of the conductor materials used. In the case of an apparatus as taught herein, however, at least one of the coil devices is not directly connected to the warm components of an outer electrical circuit, but rather is indirectly connected to this electrical circuit by means of the other coil device, wherein the electrical connecting line is cooled in the section between the two coil devices. In other words, in an embodiment comprising two coil devices, a cold/warm transition for each of the connecting lines which are arranged between the coil devices is dispensed with for each of the two coil devices. Therefore, a total of four cold/warm transitions for current supplies are saved in the case of an arrangement comprising two connecting lines between the coil devices.

A vehicle comprising the teachings of the present disclosure may be equipped with an apparatus as described above, in particular, as a drive apparatus. The vehicle may be a rail vehicle, the drive apparatus of which vehicle comprises a motor and a transformer.

The refinements of the superconducting apparatus and of the vehicle can be generally combined with one another.

The apparatus may include only one cooling apparatus to circulate coolant in the form of a closed circuit from the region of a cold head to the at least two coil devices and back. In such embodiments, the at least two coil devices of the apparatus are therefore cooled by means of a common cooling circuit. In this case, coolant can flow through said two coil devices either in parallel or sequentially. The coolant may flow through said two coil devices sequentially; in such embodiments, the order of the sequential throughflow can be selected such that the coolant first flows through the coil device with the relatively low prespecified operating temperature, as seen from the region of the cold head.

The coolant can circulate in the closed circuit in accordance with the thermosiphon principle. To this end, said coolant can be condensed in the region of a condenser which is cooled by the cold head and can be passed to the first coil device in liquid form. In some embodiments, the coolant can evaporate here owing to the absorption of heat from this first coil device and then be passed as gaseous coolant to the second coil device where it can absorb more heat from this second coil device. After that, it may be returned to the condenser for renewed condensation and the circuit is completed. However, in some embodiments, the coolant may be entirely or partially present in further liquefied form after flowing through the first coil device and only either fully or at least partially evaporate when flowing through the second coil apparatus. The evaporated portion of the coolant may be returned to the condenser and re-condensed there in this case too.

In some embodiments, the material costs for cooling the at least two components are lower since only one cooling device is required. The cooling medium required cools a plurality of components. In some embodiments, the cooling medium takes heat from a first component in liquid form and a further component as cold gas. In such embodiments, significantly less liquid cooling medium, e.g., expensive neon, is required to cool the components of the overall system. Accordingly, such a system eliminates the need for a second storage container. In contrast, known systems include two storage containers as buffer volumes for gaseous cooling medium, for example neon and nitrogen. Therefore, the space requirement for cooling the components to be cooled is considerably lower.

In addition, space and weight may be reduced because the system does away with at least one further cooling device. These advantages are extremely important in mobile applications, for example a rail vehicle. In some embodiments, the one cooling medium cools all of the components in succession in a closed cooling circuit. In this case, the operating parameters of the cooling device can moreover be adjusted to match the operation of the cooling device to the operating temperatures of the components to be cooled. By way of example, the operating pressure (vapor pressure of the gaseous cooling medium) can be adjusted in accordance with the required application.

At least one of the at least two coil devices may be connected to an outer electrical circuit by means of the at least one connecting line. In other words, at least one of the coil devices is connected to the outer electrical circuit by means of the (or a) respectively other coil device and the current supply in the connecting line. Such embodiments may provide that only cooled current supplies can be used at least for this one coil device since the connecting line is a cooled line owing to the simultaneous transportation of coolant. An additional thermal bridge through the current supply to the outer warm environment is eliminated at least for one of the coil devices in this arrangement.

For the other coil device, e.g., a transformer, the number of thermal bridges to the outer warm environment is reduced. The apparatus can also comprise a plurality of coil devices which are each indirectly connected to the outer electrical circuit only by means of their cooled connecting lines and do not have separate current supplies to the warm environment. In some embodiments, only a single one of a plurality of coil devices can be connected to the warm environment by means of separate current supplies. The apparatus may include two connecting lines between the two electrical coil devices which each comprise both an electrical conductor for electrically connecting the two coil devices and also a coolant pipe for transporting coolant between the two coil devices. In some embodiments, the two electrical conductors of these two connecting lines can serve to electrically incorporate the one coil device into a closed outer electrical circuit. At least two electrical supply lines are required for this purpose.

By way of example, the two connecting lines can be guided in parallel. However, as an alternative to the described embodiment comprising two connecting conductors, the two required electrical supply lines can also be guided, in principle, in a common connecting line, wherein the supply lines can then both be cooled by the coolant pipe which is likewise guided therein.

In some embodiments, at least one of the coil devices may be connected to at least one further connection line in addition to the connecting conductor between the coil devices. The further connection line may have both an electrical conductor for connection to an outer electrical circuit and also a coolant pipe for transporting coolant. In such embodiments, the two coil devices which are electrically connected to one another by the connecting conductor can therefore be connected to the outer electrical circuit by means of the described connection line.

The other components of said outer electrical circuit may be arranged within a warm environment and not in the cooled region of the apparatus. Therefore, the two coil devices are then electrically connected to the outer electrical circuit by means of the combination of connection line(s) and connecting line(s). The integration of a coolant pipe into the connection line or at least into a portion of the connection line has the effect that the resistance of the electrical conductor of the connection line is reduced at least for this portion owing to the cooling. Furthermore, undesired input of heat through the current supply into the coil device which is connected to the connection line can also be reduced in this case. Analogously to the various possible embodiments of the connecting line, the described connection line can also comprise either at least two current supplies for incorporating the coil devices into the outer electrical circuit, or, as an alternative, at least two connection lines of this kind can be provided, the required current supplies being guided separately in said two connection lines and each running parallel to a separate coolant pipe.

The two electrical coil devices of the apparatus may comprise superconducting coil devices. Analogously, when there are more than two coil devices, either all of these coil devices may be superconducting, or at least two of these coil devices may be superconducting. Embodiments with more than one superconducting coil apparatus may include a common cooling apparatus in a particularly efficient and space-saving manner in order to cool the two coil devices, or at least the superconducting windings of the respective coil device, to a cryogenic temperature below the critical temperature of the respective superconductor.

Furthermore, the resistive losses of the overall system can be reduced owing to the use of a plurality of superconducting coil devices in comparison to using only one superconducting coil device. In principle, the at least two superconducting coil devices can be connected to one another either electrically in parallel or electrically in series here.

The at least one superconducting coil device may comprise a coil device with windings comprising a high-temperature superconducting conductor. This conductor may comprise a second-generation high-temperature superconducting material, e.g., a compound of the type REBa₂Cu₂Oₓ, where RE is a rare earth element or a mixture of elements of this kind. In some embodiments, as an alternative to oxide-ceramic superconductors of this kind, the conductor may comprise magnesium diboride. When the apparatus has a plurality of superconducting coil devices, said coil devices can be based either on the same superconducting material or on different superconducting materials.

A first electrical coil device may comprise part of an electrical machine, and a second electrical coil device may include a transformer or part of a transformer. The electrical machine can be, e.g., either a motor or a generator. In this case, the first electrical coil device can comprise either the stator windings or the rotor windings of the electrical machine. In some embodiments, the entire apparatus serves as a drive apparatus which comprises a motor and a transformer connected upstream.

In some embodiments, the first electrical coil device can then comprise the rotor windings of the motor, in some examples, superconducting windings. The windings of the second electrical coil device may also be superconducting transformer windings. An apparatus of this kind can be used as a drive apparatus in a vehicle, e.g., a drive apparatus in a rail vehicle.

The electrical conductor of the at least one connecting line can be cooled to a cryogenic temperature by the coolant in the coolant pipe of the connecting line. In some embodiments, the coolant pipe or the coolant which is transported in the coolant pipe can be thermally coupled to the electrical conductor so effectively that the electrical conductor is at a cryogenic temperature during operation of the apparatus. In addition to good thermal coupling to the coolant, a temperature of this kind can additionally be reached by good thermal insulation of the coolant pipe and the electrical conductor against a warm outer environment. In this case, the coolant pipe and the electrical conductor may be jointly thermally insulated from the outer environment. The operating temperature of the conductor which can be achieved by these measures can lie, for example, below 100 K. In the case of a normally conducting conductor material, cooling of the electrical conductor of this kind makes a considerable contribution to reducing the electrical resistance and therefore to reducing the electrical losses.

The electrical conductor of the at least one connecting line may include a superconducting conductor material. In some embodiments, the electrical conductor can be cooled to a cryogenic temperature by said measures during operation of the apparatus. If at least one electrical conductor comprises the superconductor, the electrical resistance in the region between the two coil devices can be effectively reduced, e.g., to virtually zero. A residual resistance is then caused substantially only by the electrical connections between the (possibly superconducting) coil devices and the superconducting connecting conductor. The electrical conductor may comprise a second-generation high-temperature superconducting material, in particular a compound of the type REBa₂CuOₓ. As an alternative to oxide-ceramic superconductors of this kind, the conductor can also comprise magnesium diboride.

In some embodiments, the superconducting conductor material of the connecting line may be guided electrically in parallel to a normally conducting electrical conductor in the connecting line. As a result, large portions of the electrical losses which are caused by the conventional normally conducting current supply can be reduced. At the same time, if the superconduction in this region breaks down, there is a normally conducting parallel current path which can take on some or the majority of the current flow in this case.

The electrical conductor and the coolant pipe of the at least one connecting line can run coaxially in relation to one another. This may achieve symmetrical temperature distribution as seen over the circumference of the connecting line. By way of example, the electrical conductor can concentrically surround the coolant pipe and/or the material of the electrical conductor itself can even form the outer wall of the coolant pipe. As an alternative or in addition, one or more sections of the electrical conductor can be mounted on an outer wall of the coolant pipe. In general, at least one coolant pipe of a connecting line, in the region of its pipe casing, can have an electrically conductive material which is designed as an electrical conductor of the connecting line. In some embodiments, the coolant pipe itself can constitute the electrical conductor.

At least one electrical conductor of a connecting line can be guided in the interior of the coolant pipe. In such embodiments, coolant can directly wash around the electrical conductor or the electrical conductor can be at least thermally coupled to the coolant very effectively. This allows effective cooling of the electrical conductor to a low temperature in a particularly simple manner.

Combinations of the various described concepts are also possible, wherein a plurality of electrical conductors and/or a plurality of coolant lines are guided in a concentrically interleaved manner.

In general, the apparatus may include at least one connecting line comprising at least two coolant pipes which run coaxially in relation to one another. When there are a plurality of interleaved coolant pipes, for example, an inner coolant pipe can be provided for transporting cold coolant from a first to the second coil device, and an outer coolant pipe, which surrounds the inner coolant pipe, can be provided for returning coolant which has been heated there to the first coil device. When a counterflow principle of this kind is applied, the radially inner electrical conductors can be particularly effectively thermally insulated from the outer environment.

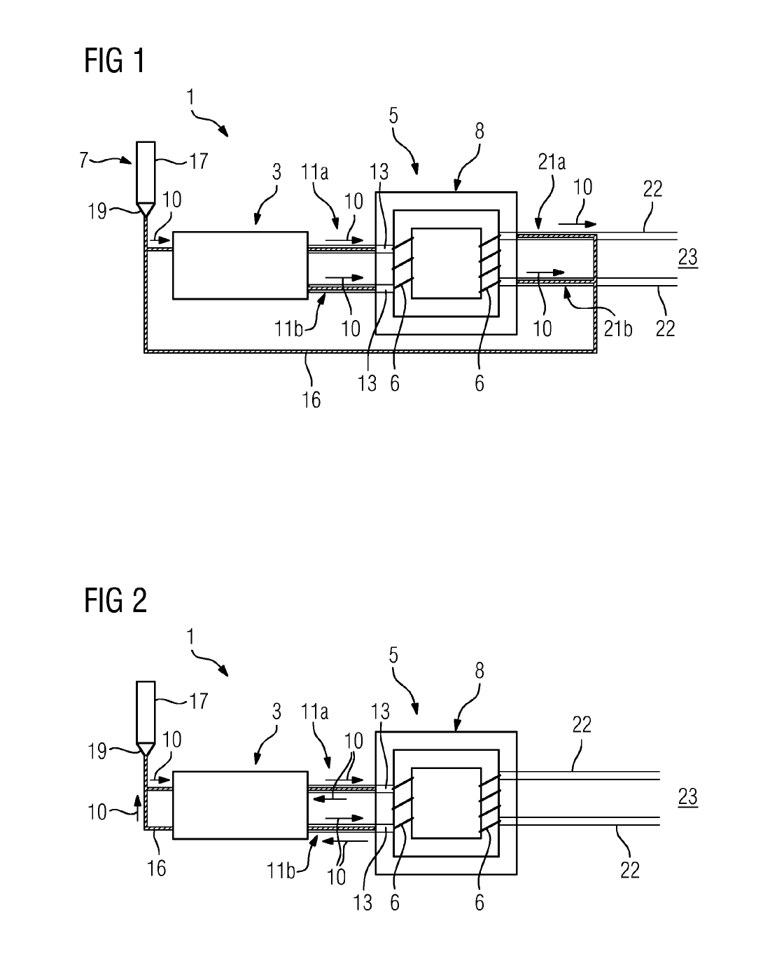

FIG. 1 shows a basic diagram of a superconducting apparatus 1 according to a first exemplary embodiment of the teachings of the present disclosure. The apparatus 1 comprises two coil devices 3 and 5, the components to be cooled of said coil devices being cooled by a common cooling apparatus 7. The cooling apparatus 7 comprises a cold head 17 which is thermally coupled to a condenser 19. The region of the condenser 19 is part of a closed cooling circuit in which a coolant circulates in a pipe system in accordance with the thermosiphon principle. The coolant is transported from the condenser in liquefied form to the components to be cooled of at least one of the two coil devices 3 and 5. Owing to the absorption of heat from these components to be cooled, the coolant can entirely or partially evaporate, so that, after running through the two coil devices, either only gaseous coolant or else a mixture of liquid and gaseous coolant is transported back to the condenser 19 by means of a return line 16. The gaseous coolant is again liquefied in the region of the condenser 19, and the circuit is completed. The coolant can comprise, for example, helium, neon, or nitrogen.

Coolant flows through the two coil devices 3 and 5 sequentially. In the example shown, the two coil devices 3 and 5 are superconducting coil devices in which the windings of the coils are formed from superconducting conductor material. The first coil device 3 comprises the superconducting rotor windings of an electrical machine. The further components of the electrical machine are not illustrated in any detail here. However, it additionally comprises a stator with normally conducting or likewise superconducting stator windings, wherein the stator radially surrounds the inner rotor. The superconducting rotor windings are composed of a high-temperature superconducting material.

The second coil device 5, which is likewise superconducting here, is a transformer with superconducting transformer windings 6 in this example. The transformer is arranged within a thermally insulating cryostat 8 to improve cooling of its superconducting windings 6. The windings 6 of the transformer are also formed with a high-temperature superconducting material here. However, the maximum operating temperature of the transformer is somewhat higher than the maximum operating temperature of the rotor windings since the rotor windings must have a relatively high critical magnetic field and therefore must be cooled to a relatively low operating temperature with the same choice of superconducting material. Therefore, the components of the apparatus 1 are arranged so that the coolant which flows in from the condenser 19 first flows through the first coil device 3 and there cools the rotor windings of the machine and only then is transported to the region of the second coil device 5, that is to say of the transformer, in the already somewhat heated and possibly partially or completely evaporated state.

In some embodiments, the rotor windings to be cooled of the first coil device 3 are also arranged in a thermally insulating vessel, not shown here, so that they are insulated from the warm outer environment. Apparatuses for coupling coolant to and decoupling coolant from the rotating components of the electrical machine, e.g., into/from an interior of a rotor shaft, are likewise not shown but are sufficiently well known from the prior art.

In some embodiments, the two coil devices 3 and 5 are connected by at least one combined connecting line 11a. In the first exemplary embodiment shown, two connecting lines 11a and 11b of this kind are arranged between said coil devices, wherein each of these connecting lines has an electrical conductor and a coolant pipe for transporting coolant. Various embodiments for the detailed construction of these connecting conductors are described in greater detail below. However, they share the common feature that the electrical conductor of the connecting line is guided as part of a common line together with the coolant pipe and is thermally effectively coupled to said coolant pipe.

This combined current and cooling line may be effectively thermally insulated from the outer environment, for example by a sheathing with vacuum insulation and/or wrapping by so-called superinsulation. The electrical conductor of the connecting line is likewise at a low operating temperature owing to the thermal coupling to the coolant and may have a high-temperature superconducting material connected electrically in parallel to a normally conducting conductor. In such embodiments, the electrical losses in the supply line for the first coil device 3 are considerably reduced in comparison to known designs with warm supply lines. Furthermore, an additional thermal bridge may be avoided in the region of the first coil device 3 owing to a direct connection to a warm outer circuit.

The second coil device 5, e.g., the superconducting transformer, includes two additional outer connection lines 21a and 21b. These connection lines 21a and 21b each also have a region which is connected to the second coil device 5 and in which the coolant pipe and the electrical conductor of the respective connection line are guided together in a combined line. Following this common region, the coolant pipe of the respective connection line is connected to a common return line 16 for returning the coolant, and the electrical conductors are electrically connected to the other, warm components of an outer electrical circuit 23, not shown in detail here, by means of separate current supplies 22.

In the embodiment shown, the apparatus 1 has two connecting lines 11a and 11b which run parallel to one another and which each comprise an electrical conductor and a coolant pipe, and in which the superordinate flow direction 10 of the coolant is the same. Here, coolant therefore flows through the first coil device 3 and the second coil device 5 by means of the two lines in succession in the same order. However, in other embodiments, the flow directions of the coolant can run opposite one another in two connecting lines 11a and 11b which run next to one another, so that a closed coolant circuit is already produced by these connecting lines, without a separate return line 16. In some embodiments, two or more conductors, which are required for electrical contact-making, can also be guided within a common connecting line 11a together with a coolant pipe. Therefore, it may be sufficient to arrange only one single connecting line 11a between the two coil devices.

FIG. 2 shows a basic illustration of an apparatus 1 according to a second exemplary embodiment. Some components are arranged analogously to the first exemplary embodiment and are provided with the same reference symbols. However, in contrast to the first exemplary embodiment, no separate, outer return line 16 is connected to the second coil device 5 here, but rather the two connecting lines 11a and 11b each comprise two coolant pipes by means of which coolant can be transported both from the rotor to the transformer and back to the rotor and from said rotor back to the condenser 19. This is indicated in each case by the two opposite flow directions 10 for each of the two connecting lines. Various configurations for the connecting conductors 11a and 11b, which are explained in greater detail in the text which follows, are also possible in an arrangement of this kind. In this embodiment, the current supplies of the second coil device 5, e.g., the transformer windings here, are connected to the outer electrical circuit 23 by means of separate current supplies 22. However, in principle, there may be a coolant flow in the region of these current supplies to reduce the line resistances. In this case, both normally conducting and superconducting line materials can be used for the current supplies.

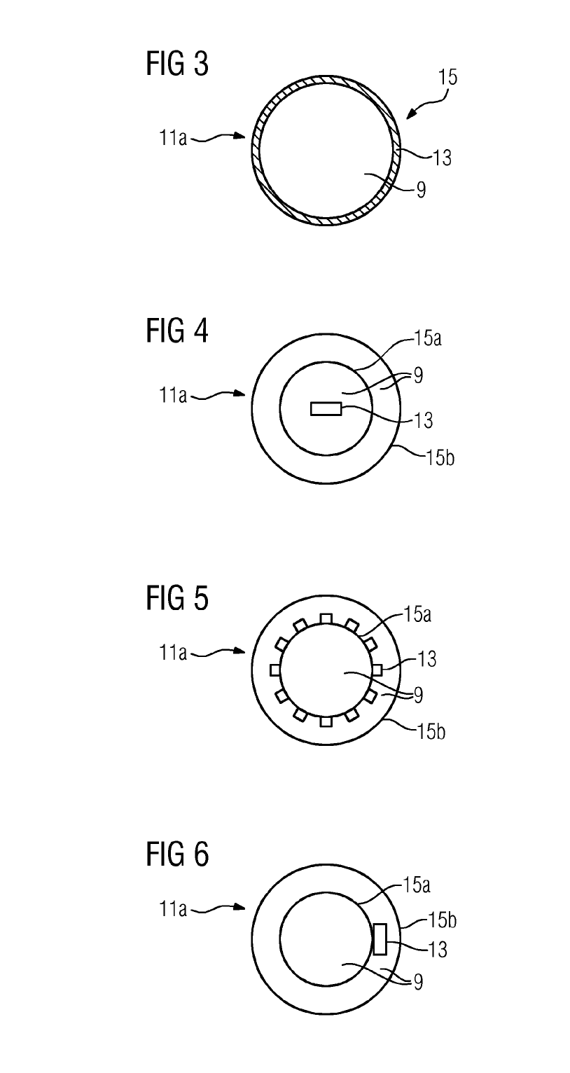

FIG. 3 shows a schematic cross section through a connecting line 11a for one of the above-described apparatuses 1. The connecting line 11a of this embodiment may be included for use with apparatus 1, as is illustrated in FIG. 1, since there the coolant flows in each of the connecting lines 11a, 11b only in one direction 10. The connecting line 11a shown in FIG. 3 comprises a coolant pipe 15 with liquid and/or gaseous coolant 9 being transported in the interior of said coolant pipe. The coolant pipe 15 has, in the region of its pipe casing, at least one electrically conductive material which acts as an electrical conductor 13 of the connecting line. By way of example, the pipe casing can be formed from copper, and the cross section of the copper can be sufficient to be able to ensure the current flow to be transported from the current supply. The coolant pipe 15, which therefore simultaneously serves as an electrical conductor 13, can be electrically and thermally insulated from the outer environment by further sheathing and/or wrapping.

In some embodiments, the pipe casing may be coated with an electrically conductive material of which the conductivity and cross section are sufficient to be able to transport the required current. The coating may include a superconducting coating of a conductive or else nonconductive pipe, e.g., magnesium diboride which can be deposited on rounded surfaces in a simple manner, for example, by means of aerosol deposition.

In addition to the constituent parts shown in FIG. 3, the connecting line 11a may include a further coolant pipe which surrounds the inner pipe 15 and which can transport, for example, coolant in the direction opposite the inner pipe. An arrangement of this kind may further cool a superconducting layer deposited on the outside of the pipe 15. The resulting connecting line 11a would therefore also be suitable for use in the apparatus shown in FIG. 2.

FIG. 4 shows a schematic cross section of an alternative connecting line 11a according to a fourth exemplary embodiment. The figure shows an inner coolant pipe 15a which is radially concentrically surrounded by an outer coolant pipe 15b. The electrical conductor 13 may include a superconducting or as a normally conducting wire. Electrical conductor 13 is guided within the inner coolant pipe 15a. More complex conductive constructions comprising a plurality of materials and layers, in which superconducting conductors and normally conducting conductors can also be connected electrically in parallel for example are also feasible.

Coolant respectively flows within the two shown coolant pipes 15a and 15b, wherein the flow directions in the two pipes may be opposite, to cover both transportation directions of the coolant by means of one connecting conductor. The coolant in the inner coolant pipe 15a may be the relatively cold coolant arriving from the condenser, and therefore the electrical conductor 13 arranged therein is cooled to a greater degree. The electrical conductor can, as indicated in FIG. 4, be guided relatively centrally within the inner pipe 15a by apparatuses not shown in any detail here. However, as an alternative, said electrical conductor can also be held in the region of one side of the inner wall of the inner pipe 15a, since this can be easier to reach. The electrical conductor 13 can be electrically insulated from the coolant pipes 15a and 15b. Effective thermal coupling of the conductor 13 to the through-flowing coolant may increase the effectiveness of the overall system.

FIG. 5 shows a schematic cross section of an alternative connecting line 11a according to a fifth exemplary embodiment. Said figure shows two interleaved coolant pipes 15a and 15b through the interior of each of which coolant 9 flows. In this example, a plurality of electrical conductors in the form of individual conductor filaments are mounted on the outer side of the inner pipe 15a, so that coolant which is transported in the outer coolant pipe 15b washes around these conductor filaments. Furthermore, said conductor filaments are thermally coupled by means of the material of the inner coolant pipe 15a to the coolant flowing in said inner coolant pipe. In this case, either the coolant flowing on the outside or the coolant flowing on the inside can form the colder of the two coolant flows. In some embodiments, the filaments of the electrical conductor 13 are cooled by the coolant 9 to such an extent that the resistance in comparison to the ambient temperature is considerably reduced. In this case, the electrical conductors 13 can once again comprise either normally conducting materials and/or superconducting materials.

FIG. 6 shows a schematic cross section of an alternative connecting line 11a according to a sixth exemplary embodiment. Said figure shows two interleaved coolant pipes 15a and 15b through the interior of each of which coolant 9 flows. In this example, only one electrical conductor 13 is mounted on the outer side of the inner pipe 15a, so the pipes are asymmetrical and non-concentric. The rectangular cross section of the electrical conductor 13 is only exemplary in this case. Cross-sectional shapes different to those shown can also be used both in the case of the coolant pipes 15a, 15b and also in the case of the conductor 13. In addition, the size relationships between the pipes 15a, 15b and the conductors 13 are generally not true to scale, and the drawings are intended to be understood only as schematic diagrams.

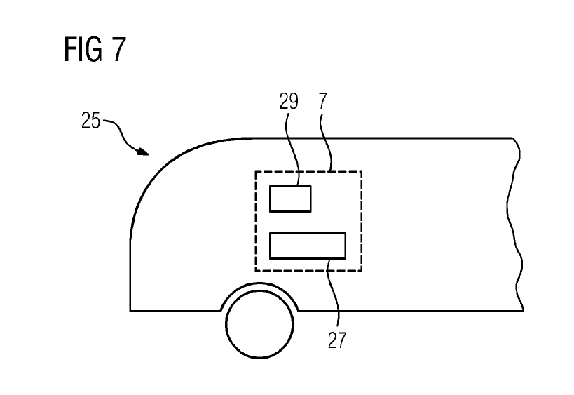

FIG. 7 schematically shows a vehicle 25 according to the invention which is in the form of a rail vehicle in this example. Said vehicle has one of the above-described apparatuses 1, wherein this apparatus comprises a machine 27 with superconducting rotor windings and a superconducting transformer 29. The two components are cooled by the common cooling apparatus 7, as has been explained in FIGS. 1 and 2.

Although the teachings herein have been illustrated and described in more detail by the exemplary embodiments, they are not restricted by the disclosed examples and other variations can be derived therefrom by a person skilled in the art without departing from the scope of these teachings.

What is claimed is:

1. A superconducting apparatus (1), comprising:
two electrical coil devices;
wherein at least one of the two electrical devices comprises a superconducting coil device;
a cooling apparatus for the coil devices; and
a first connecting line between the two electrical coil devices, the first connecting line including both a first electrical conductor connecting the two coil devices and a first coolant pipe transporting coolant between the two coil devices.

2. The superconducting apparatus as claimed in claim 1, comprising one and only one cooling apparatus;
wherein the cooling apparatus circulates the coolant in a closed circuit from a cold head to the two coil devices and back.

3. The superconducting apparatus as claimed in claim 1, wherein the first connecting line provides electrical connection between one of the two electrical coil devices and an outer electrical circuit.

4. The superconducting apparatus as claimed in claim 1, further comprising a second connecting lines between the two electrical coil devices;
wherein each connecting line comprises an electrical conductor connecting the two coil devices and a coolant pipe transporting coolant between the two coil devices.

5. The superconducting apparatus (1) as claimed in claim 1, further comprising a second connecting line providing an electrical conductor to an outer electrical circuit and a coolant pipe to one of the two coil devices.

6. The superconducting apparatus as claimed claim 1, wherein the two electrical coil devices comprise superconducting coil devices.

7. The superconducting apparatus as claimed in claim 1, wherein one of the electrical coil devices comprises part of an electrical machine, and a second electrical coil device comprises a transformer.

8. The superconducting apparatus as claimed in claim 1, wherein the two electrical coil devices have differing maximum operating temperatures; and
the cooling apparatus conducts the coolant from a cold head first to a first electrical coil device with a lower maximum operating temperature and then by means the connecting line to a second coil device with a higher maximum operating temperature.

9. The superconducting apparatus as claimed in claim 1, wherein the electrical conductor of the connecting line is cooled to a cryogenic temperature by the coolant in its coolant pipe.

10. The superconducting apparatus as claimed in claim 1, wherein the electrical conductor of the connecting line comprises a superconducting conductor material.

11. The superconducting apparatus as claimed in claim 1, wherein the electrical conductor and the coolant pipe of the connecting line run coaxially to one another.

12. The superconducting apparatus as claimed in claim 1, wherein the connecting line includes at least two coolant pipes running coaxially to one another.

13. The superconducting apparatus as claimed in claim 1, wherein which at least one coolant pipe of the connecting line includes an electrically conductive material in the region of its pipe casing, wherein the electrically conductive material comprises an electrical conductor of the connecting line.

14. The superconducting apparatus as claimed in claim 1, wherein the electrical conductor of the connecting line is guided in the interior of a coolant pipe.

15. A vehicle comprising a drive apparatus, wherein the drive apparatus comprises:
two electrical coil devices;
wherein at least one of the two electrical devices comprises a superconducting coil device;
a cooling apparatus for the coil devices;
a first connecting line between the two electrical coil devices, first connecting line including both a first electrical conductor connecting the two coil devices and a first coolant pipe transporting coolant between the two coil devices.
